(19) United States
(12) Patent Application Publication
(10) Pub. No.: US 2003/0105650 A1
(43) Pub. Date: Jun. 5, 2003

(54) Cooperative planning system and method

(76) Inventors: Joseph S. Lombardo, Annapolis, MD (US); Richard A. Wojcik, Columbia, MD (US); Wayne A. Loschen, Odenton, MD (US); David M. White, Silver Spring, MD (US); John F. Dicello, Timonium, MD (US); Lee T. Myers, Merian Station, PA (US); Raymond Gaudette, Oella, MD (US)

Correspondence Address: Francis A Cooch, The Johns Hopkins University, Applied Physics Laboratory, 11100 John Hopkins Road, Laurel, MD, 20723-6099, US

(21) Appl. No.: 10/030,004

(22) PCT Filed: Mar. 7, 2001
(86) PCT No.: PCT/US01/07125

(51) Int. Cl. G06F 17/00

(52) U.S. Cl. 705/2; 707/104.1; 600/300

(57) ABSTRACT

A medical treatment planning system which enables multiple collaborators in different locations to interactively view and manipulate data for use in, for example, preparing a treatment plan while also interacting with each other. Interactive medical treatment planning involving multiple participants using multiple treatment planning stations includes establishing one of the treatment planning stations as a session controller and launching treatment planning software thereon; establishing a communication connection between the session controller planning station and all of the treatment planning stations participating in a planning session; and displaying, on all participating treatment planning stations, treatment plan information being displayed on the session controller treatment planning station. The system also designates one of the treatment planning stations as an active controller for controlling manipulation of the treatment planning information, which may be regulated by the session controller treatment planning station.

### CROSS-REFERENCE TO RELATED APPLICATIONS

This application claims the benefit of prior-filed U.S. Provisional Application No. 60/187,521, filed on Mar. 7, 2000.

### BACKGROUND OF THE INVENTION

1. Field of the Invention

The present invention relates to a method and system for medical treatment planning and more particularly to a method and system for medical treatment planning involving interactive communication between medical personnel at diverse locations, and real-time viewing and manipulation of the same data by all parties utilizing the system.

2. Description of the Prior Art

Traditionally, when a patient needed medical consultation and/or treatment, the patient had to travel to the location of the medical professional(s) providing the diagnostic, planning, and treatment services. Complex medical treatments (e.g., radiation therapy) typically involve a collaborative effort between various members of one or more departments within a medical institution. For example, with respect to radiation therapy, within a Radiation Oncology Department there may be radiation physicists, dosimitrists, radiation oncologists, and other similar medical professionals, all of whom may provide important input when putting together a treatment plan. A dosimitrist measures and generates radiation dose distributions and calculations, and an oncologist prescribes and oversees a course of radiation therapy. The dosimitrist works with treatment planning computers and other manual data in assisting the radiation oncologist prescribe the proper dose. Additionally, peer reviewers are often utilized so that the treatment plan developed by a collaborative team is independently evaluated to assure that the proposed treatment plan is appropriate, as well as to solicit the opinions of other experts in the field. In the past, the members of the collaborative team were typically located in the same facility.

The majority of major medical centers are located in or near large cities. Radiation and other complex treatments often require many doses of a particular treatment to be performed on a daily basis for an extended period of time, e.g., for six to eight weeks. Thus, for a patient living in a rural or remote area, travel to a larger city on a daily basis for an extended period of time can be time-consuming and physically taxing. Further, frequently such patients are debilitated to some degree due to the illness for which they are receiving treatment, and may require the assistance of a support person, such as a family member, to get to and from the medical facility. This can make it even more difficult for the patient to obtain treatment.

As a result of the above-described issues, it is becoming more and more common for the larger medical centers to handle the diagnostic and treatment planning aspects of a particular medical treatment, while having the actual treatment delivered at a site located closer to the patient's place of residence. This remote method of treatment, while providing advantages to the patient, is inhibiting to the medical personnel involved in the planning and care delivery, since they often cannot meet in person for their collaborative efforts. When facilities first began utilizing remote treatment methods, most of the collaborative effort between the treatment planning site and the care delivery site were handled by telephone and facsimile; with advancements in computer technology, email and electronic transfer of images were also utilized. While this method works adequately, each collaborator is viewing his or her own set of documents, images, etc., leading to the possibility that one or more of the collaborators is viewing the wrong document or a degraded version of the original.

Systems have been developed to allow a physician to communicate electronically using, for example, video/voice connections so that a patient at a remote location (e.g., at home) can see an image of the physician and thus feel more like the physician is actively involved in the remote consultation. Some examples of such systems can be found in U.S. Pat. Nos. 5,553,609 to Chen et al.; 5,619,991 to Sloan; and 5,911,687 to Sato et al. These systems allow the physician and other persons who may be working with the physician to view electronic versions of documents (e.g., a patient file or an MRI scan) while communicating with the patient While such methods do assist the physician and other medical personnel in remotely conducting collaborative efforts, these methods suffer from the same, previously-described problems. Since collaborators at their respective locations are viewing their own set of materials (e.g., they view downloaded or emailed documents and/or use documents that are archived locally), there is always the possibility that one or more of the participants is either looking at an old version of a document. In addition, because they may be viewing copies of a document, the document itself may suffer from degradation due to the copying process, and therefore not be an accurate representation of what it is supposed to be portraying. Further, it may be difficult for the various participants to articulate to the other parties the location of a particular element in an image that they are viewing and discussing, since activity (e.g., movement of a pointer) on a computer at one location is not replicated or viewable at other locations.

Accordingly, it would be desirable to have a treatment planning system which enables multiple collaborators in different locations to interactively view and manipulate data for use in, for example, preparing a treatment plan while also interacting with each other.

### SUMMARY OF THE INVENTION

The present invention is a treatment planning system which enables multiple collaborators in different locations to interactively view and manipulate data for use in, for example, preparing a treatment plan while also interacting with each other. In accordance with the present invention, a method is disclosed for interactive medical treatment planning involving multiple participants using multiple treatment planning stations, comprising the steps of: (a) establishing one of the treatment planning stations as a session controller and launching treatment planning software thereon; (b) establishing a communication connection between the session controller planning station and all of the treatment planning stations participating in a planning session; and (c) displaying, on all participating treatment planning stations, treatment plan information being displayed on the session controller treatment planning station.

In a preferred embodiment, the method of the present invention further includes the step of designating one of the treatment planning stations as an active controller, with the active controller controlling manipulation of the treatment planning information. In a preferred embodiment, the active control of the treatment planning session is regulated by the session controller treatment planning station.

### BRIEF DESCRIPTION OF THE DRAWINGS

FIG. 1 illustrates an example of a typical hardware configuration on which the method of the present invention may be practiced;

FIG. 2 illustrates an example of typical architecture of the present invention; and

FIG. 3 is a flowchart illustrating an example of steps performed in connection with the present invention for a typical radiation therapy treatment.

### DESCRIPTION OF THE PREFERRED EMBODIMENT(S)

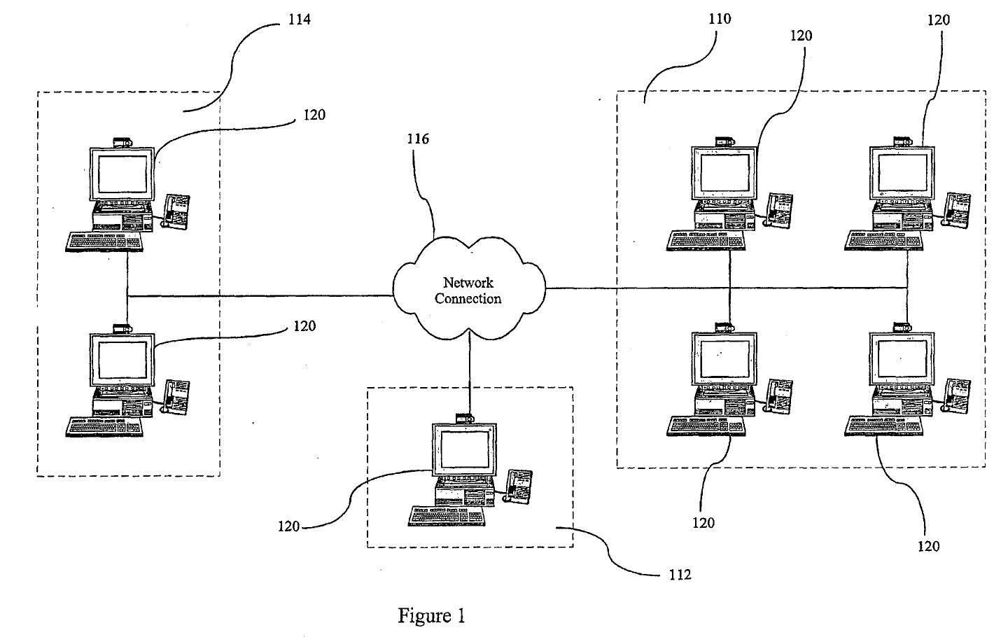

FIG. 1 illustrates an example of a typical hardware configuration on which the method of the present invention may be practiced. It is understood that the present invention is not limited to this configuration and the components described herein; they are provided by way of example to help explain the method of the present invention and an environment in which it could operate.

For the purpose of this example, the term “treatment planning site” refers to a main medical facility, such as The Johns Hopkins Hospital Oncology Center in Baltimore, Md., and the term “care delivery site” refers to a remote location where the medical treatment defined in the treatment plan would be delivered, such as, for example, The Johns Hopkins Green Spring Clinic in Lutherville, Md. or the Peninsula Regional Medical Center in Salisbury, Md. It is understood that it is not necessary that the treatment planning site and the care delivery site be at different locations.

Referring to FIG. 1, a treatment planning site 110, a care delivery site 112, and a peer review site 114 are interconnected via a network connection 116 in a well known manner. It is understood that each of the sites 110, 112, and 114 may be in the same city, may be in different cities, different countries, or at different locations within the same building. In a typical embodiment of the present invention, the treatment planning site 110 is located in an urban center, e.g., the city of Baltimore, and the care delivery site 112 is located in a more rural or remote geographic location, e.g., Maryland's Eastern Shore. The peer review site 114 can be located at the same facility as treatment planning site 110 or at a location (e.g., a university) separate and apart from treatment planning site 110.

Each of the sites 110, 112 and 114 include workstations (“treatment planning stations”) for participation in any interactive planning sessions that may occur. Although it would be preferable that all of the workstations 120 be identical, they may also be different, both in terms of hardware and the platform that they utilize to operate. For example, the workstation 120 located at care delivery site 112 may be a UNIX or Windows platform, while the workstations 120 at the treatment planning site 110 or peer reviewing site 114 may be Macintosh-based systems.

Each of the workstations 120 must be able to support real-time, multi-point data and video communications, e.g., compliant with the ITU T.120 and H.323 conferencing standards. This can be accomplished using session controller software, discussed below, typically running on a computer at the treatment planning site 110. Further, all of the workstations 120 must be able to display images at an appropriate resolution, color depth, and size to enable persons using the system to be able to discern significant image characteristics that affect treatment planning. These parameters are well known in the field of medical imaging and treatment planning.

The workstations 120 must be able to view a treatment planning software program (a “host application”) running on one of the treatment planning workstations which has been designated as the “session controller,” to enable all collaborators to seamlessly interact with each other. One example of such a software program is the ADAC Pinnacle treatnent-planing software which is hosted on a Sun MicroSystems UNIX workstation. Each workstation 120 must also be configured to perform video conferencing by utilizing, for example, MicroSoft Net Meeting (Windows/Intel platforms) or Sun SunForm for Sun platforms, or other commercial T.120 compliant software, and conventional video conferencing hardware including a video camera and microphone. In addition, each platform may be equipped with image rendering software, preferably DICOM 3.0 compatible software, such as Accusoft ExamiNet, to facilitate sharing of DICOM-compatible images and patient information.

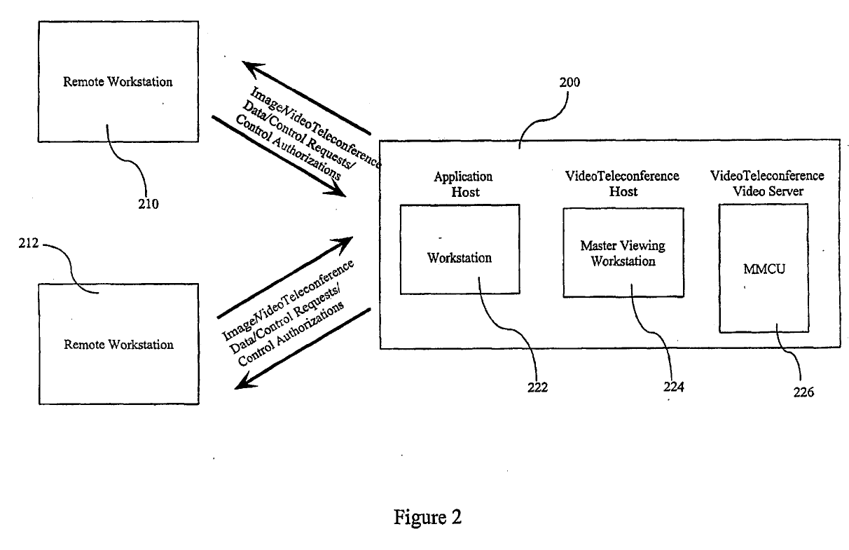

In accordance with the present invention, all of the sites or workstations participating in the conference will share a common view of the host application running on the session controller, and they may also share control of the host application. FIG. 2 illustrates an example of typical architecture for the present invention. As shown in FIG. 2, the conference session controller 200 (as noted above, typically at the treatment planning site 110) includes an application host system 222, a video teleconference host system 224, and a video teleconference video server 226. Application host 222 can comprise, for example, a Pinnacle workstation, including sufficient memory storage capability to store large volumes of large-size image data and other data. If the Pinnacle system is employed, a single set of data will be manipulated. However, if not employing the Pinnacle system, more than one set of data can be manipulated. It is understood that a separate file server (not shown) can be provided to provide separate and more robust storage capability.

Referring to FIG. 2, a client or remote site workstation 210 or 212 requests to join the conference and share the application running on an application host server 222. The video teleconference video server 226 grants or denies access to the conference. As the workstation joins the conference, the host “view” of the host application running on the host application server 222 is sent to the workstations 210 and 212, so that every viewer of the conference is viewing the identical image as that being displayed on the application host server 222. If the image displayed on the application host server 222 changes, so does the image displayed on the remote site workstations 210 or 212. This assures the integrity of the conference since everyone is always assured of viewing the same image at all times.

Use of the present invention allows multiple workstations to collaborate in a common conference session. In a preferred embodiment, the conference session controller 200 will coordinate and have ultimate control of the session and will establish and maintain the session. Image manipulation (e.g., contouring, rotation, pointing to locations, etc.) will be allowed at all workstations to facilitate multi-site review of the treatment plan. However, coordination is needed among the collaborators at the various sites to avoid conflicts for control of the host application. To take control of the host application (i.e., take “active control” of the host), an operator of a workstation must submit a request for control (an “active-control request”). The operator of the application host server at the video teleconference host 224, which can be, for example, a master workstation, will either grant or deny the request. If granted, the requesting workstation will be given active control and will remain in active control of the host application until it relinquishes control or is preempted by the operator of the application host server 222. The operator of the application host server 222 always has preemptive control of the session.

As control commands are sent to the shared host application, the application host will update its display. As the application host updates its display, the content of the display will be sent to each of the workstations. Since it is likely that various workstations will render the images at various processing speeds, preferably the rate at which image manipulation requests are displayed will be that of the image render rate of the slowest workstation in the session. In a preferred embodiment the display on all machines would be essentially instantaneous, however, in practice the rate of display is limited by the slowest workstation. The video teleconferencing enables the actions taken by the participants in the conference to be seen and heard and to communicate their intent directly; this minimizes any confusion that might occur if the participants were attempting to interact only by computer (and without the sight or voice cues available with video conferencing). The video teleconference video server 226, which can be, for example, a Multimedia Multi-point Control Unit (MMCU), and its associated software, allows the video image of multiple participants to be displayed and viewed by the other participants simultaneously, and in a known manner automatically switches the audio to the person actively speaking at any given time.

At the end of the session, the decision to save the “image set” (those images that are used and/or modified during the conference) is preferably made by the conference application host. In a preferred embodiment, it will be understood and agreed upon by all participants in the conference that only the operator of the application host server will be allowed to issue the command to save the treatment plan on the data server, thus assuring that the appropriate treatment plan is saved. Approval by authorized individuals will be required to update treatment plans before they can be used for care delivery.

In addition to sharing the host application, a user at a workstation may also have ancillary images or text that need to be shared with the participants at other workstations. In order to share information, the originator of the ancillary data will send the data to the conference session manager for temporary storage in a shared directory dedicated to the session. The other workstations can retrieve the ancillary data at any time during the session.

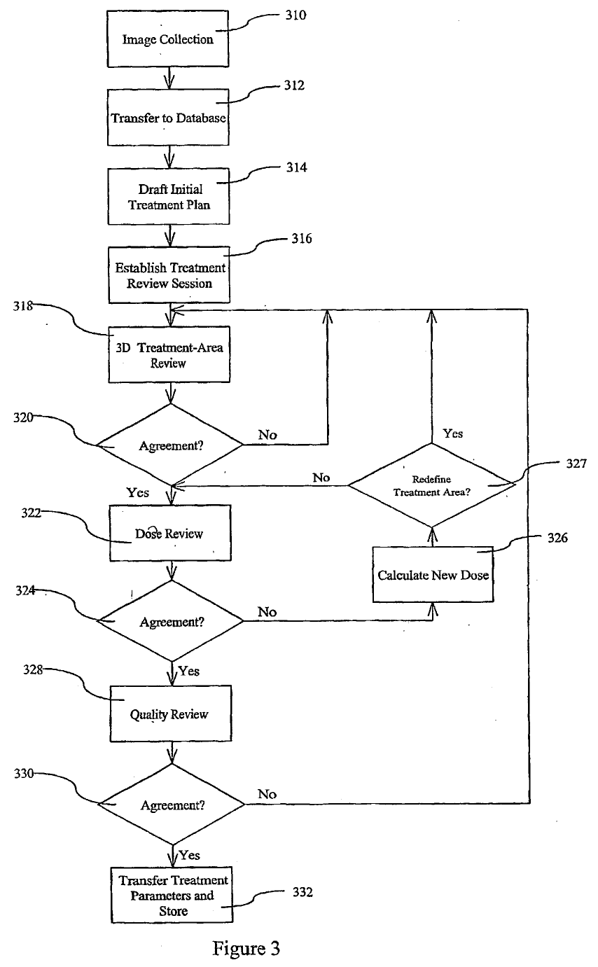

FIG. 3 is a flowchart illustrating an example of the steps performed in connection with the present invention for a typical radiation therapy treatment. It is understood that similar steps would be carried out for any type of medical treatment involving a collaborative effort between medical personnel.

Referring to FIG. 3, at step 310, images of the treatment volume, e.g., a tumor, are obtained. These can be obtained by any known means, for example, from a CT scan, or an MRI. These images can be obtained at the care delivery site, the treatment planning site, or any other supporting facility. At step 312, the obtained images, stored in electronic form (e.g., in DICOM 3.0 format), are transferred to a remote treatment database located at the treatment planning site. The remote treatment database is simply a database program with appropriate storage capability, and can reside on, for example, a personal computer or server with memory allocated for remote treatment data storage, or any other data storage device.

At step 314, an initial treatment plan is drafted at the treatment planning site. The initial treatment plan, in the context of radiation therapy for a tumor, would typically include definition of the gross tumor volume, clinical tumor volumes, planning treatment volume, dose clouds, beam angle, and intensity parameters. At step 316, a treatment review session is established between the staff at the treatment planning site (e.g., the dosimitrists) and the staff at the care delivery site (e.g., the oncologist at the remote treatment facility). If desired, this initial treatment review session can also include peer review participants providing their input regarding the proposed treatment plan.

The treatment review session involves collaborative interaction between all of the parties to the session. As described above, participants at each location simultaneously view the same image(s). Video conferencing capability is also provided, with the video display appearing on the screen but in a position so as not to impede the view of the image(s), e.g., in one corner of the screen.

As discussed above, the process of the present invention includes the capability for any of the participants to “take control” of the treatment review session as desired. For example, if an oncologist at the care delivery site wishes to point to a particular element of an image being viewed and discuss it with the other parties and/or suggest areas on which to focus treatment, or otherwise manipulate an image, the oncologist can request “control” of the session via a keyboard input or a voice request, which is then processed by a session controller.

The session controller, in a preferred embodiment, is located at the treatment planning site and can comprise a computer configured to control the session and authorize, deny, and cancel control of sessions among the participating workstations. Conventional software exists to configure the session controller computer to perform its control functions. Obviously, however, the session controller can be located at any location as long as it is connectable to participate in the session. Once in control of the session, the oncologist can move a mouse pointer or other designator to a particular area of the image being viewed by all parties to point, with precision, at the area he or she wishes to discuss; all other participants in the session will view the oncologist's mouse pointer movement and see precisely the location in the image that he or she is discussing over the video conference.

A typical treatment review session would include a 3-dimensional treatment-area review (step 318) of the gross tumor volume and the proposed clinical and planning treatment volumes set forth in the initial treatment plan. Because of the ability to interact with each other in real-time as though all in the same room, the participants in the session can express their points of view and quickly reach agreement as to the appropriate area to treat. If agreement is not reached at step 320, the process reverts back and additional 3D treatment-area reviews are conducted until agreement can be reached.

Once agreement is reached, at step 322 a dose review is conducted. The purpose of the dose review is to come to an agreement as to the appropriateness of the treatment parameters outlined in the initial treatment plan to be used in treating the tumor, e.g., beam angles, intensities, etc. The dose and its application of the treatment volume are reviewed and input is solicited from all session participants. If the dose needs to be modified as a result of the review, multiple options may be available. For example, new beam angles and intensities can be calculated using well known treatment planning calculation software which can be provided as part of the treatment planning system software being used by the participants; alternatively, a “Monte Carlo” simulation can be performed to refine the dose parameters by launching a stand-alone program which runs the Monte Carlo simulator and then providing the results to all participants.

During the dose review step (step 322), there may be modifications suggested to the area of definition defined during the 3D treatment-area review. If so (see step 327), the process returns to conduct an additional 3D treatment-area review at step 318; once agreement is reached on both treatment area and treatment dose, at step 328 quality control procedures can be utilized to assure that the final plan is optimal. This quality review step may include input from peer reviewers (peer review may be conducted at any stage of the process). Once quality review is completed and the plan has been approved, at step 332 the treatment plan is archived, e.g., at the treatment planning site, the care delivery site, in a treatment system database, and/or any other desired locations.

The specific hardware required for operation of the present invention can comprise conventional hardware. Remote treatment planning, as described herein, requires the transfer of large, high-resolution image sets needed to define three-dimensional treatment volumes and surrounding organs. Manipulation of these images must be able to be performed in real-time among the sites supporting the generation of the plan and the delivery of the treatment. The telecommunications infrastructure must be able to support the transfer and manipulation of large image files in a secure, collaborative video teleconferencing environment. Such technology currently exists; however, bandwidth limitations limit the speed with which the present invention will operate. As telecommunications infrastructure advances, such as with the ‘Next Generation Internet’ (NGI), specific NGI technologies will become available which will substantially increase bandwidth and security protection related to Internet transmission and it is contemplated that the development of these telecommunications technologies will increase the speed with which the present invention will operate.

Regarding security, protection of personal-identifiable electronic health data against access, alteration, destruction, corruption, etc., must be implemented and should follow the guidelines and recommendations of the National Research Council's Computer Sciences and Telecommunication Board study of best practices for protecting the confidentiality of health data, and the Security Level 3 of the DHHS Automated Information Security Program Handbook. Other guidelines and references, such as the NIST Guide for Developing Security Plans for Information Technology Systems, NIST Special Publication 800-18, may also be used to guide the development of the security plan. The details of the particular security plan are not a critical aspect of the present invention; any known or developed security system, including the use of firewalls, password protection, etc., which will protect the integrity of the electronic health data may be used.

While FIG. 1 illustrates three remote sites and a total of seven workstations, there is essentially no limit to the number of sites that may enter the review session. The only limitation is the number of site licenses for software and any limitations imposed by the telecommunications connections. However, it is anticipated that the number of sites involved in the review sessions will usually not exceed three.

Use of the remote control of the treatment planning software and video teleconferencing enables interactive review and discussion by all participants in a session for the plan. The features of the plan may include gross tumor, clinical target, and the planned treatment volume(s); critical structures where radiation doses need to be limited; treatment fields, digitally-reconstructed radiographs, dose volume histograms, and dose distributions on a variety of imaging modalities; comparison of alternate plans to determine the best plan for optimal patient treatment; validation and verification of individual treatment fields on a treatment simulator at the remote site; revision of individual treatment fields in terms of weighting, field size, blocking, compensation, use of beam modifiers, and the submission of revisions for new dose calculations; and assembly of information relevant to the treatment for peer review by physicians at any site, such review to include the treatment plan, dose-volume histograms, digitally-reconstructed radiographs, and port films.

Use of the present invention allows coordination and cooperation among all of the geographically diverse practitioners as though they are all located in the same room conducting their discussions. Each party to the cooperative session sees the same view on their computer screens, thereby limiting the possibility of errors.

Using the present invention, distances between facilities do not pose significant problems to practitioners attempting to develop a cooperative plan, and recipients of treatments developed during the cooperative planning sessions may minimize long distance travel to obtain required treatments.

The foregoing is considered as illustrative only of the principles of the invention. Further, since numerous modifications and changes will readily occur to those skilled in the art, it is not desired to limit the invention to the exact construction and applications shown and described. For example, while the invention disclosed herein relates to medical treatment planning, it is not intended to be so limited and can be used for any collaborative planning in which a single data set is to be viewable and maniputable by planners at different locations. Accordingly, all suitable modifications and equivalents may be resorted to, falling within the scope of the invention and the appended claims and their equivalents.

1. A method for interactive medical treatment planning involving multiple participants using multiple treatment planning stations, comprising the steps of:
(a) establishing one of said treatment planning stations as a session controller and launching treatment planning software thereon;
(b) establishing a communication connection between said session controller treatment planning station and all of said treatment planning stations participating in a planning session; and
(c) displaying, on all participating treatment planning stations, treatment plan information being displayed on said session controller treatment planning station.

2. A method as set forth in claim 1; further comprising the step of:
(d) designating one of said treatment planning stations as an active controller, said active controller controlling manipulation of said treatment planning information.

3. A method as set forth in claim 2, wherein said active control of said treatment planning session is regulated by said session controller treatment planning station.

4. A method as set forth in claim 3, wherein step (d) comprises at least the steps of:
(e) generation of an active-control request by a treatment planning station;
(f) processing of said active-control request by said session controller treatment planning station; and
(g) authorizing or denying said active-control request by said session controller treatment planning station, wherein if said active-control request is granted, said treatment planning station generating said active-control request is given active control of said treatment planning session, and if said active-control request is denied, said treatment planning station generating said active-control request is denied active-control of said treatment planning session.

5. A method as set forth in claim 4, wherein at least two of said treatment planning stations are located in geographically diverse locations.

6. A method as set forth in claim 5, wherein each of said treatment planning stations includes video conferencing capability, and wherein said method further comprises the step of:
(h) transmitting video and audio signals using said video conferencing capability of said treatment planning stations so that participants to said treatment planning session can see and hear the other participants in the session while the session is in progress.

7. A method as set forth in claim 6, wherein said treatment planning session is for planning radiation therapy and said participants in said treatment planning session include at least a dosimitrist and a radiation oncologist, each located at a geographically diverse location.

8. A method as set forth in claim 7, wherein said treatment planning stations are coupled to each other via a network connection.

9. A method as set forth in claim 8, wherein said network connection comprises the Internet.

10. A method as set forth in claim 8, wherein said network connection comprises the Next Generation Internet (NGI) or other high bandwidth connection.

11. A method as set forth in claim 9, wherein said manipulation of said treatment plan information includes at least one of contouring, rotating, or pointing at locations in images being displayed on said treatment planning stations and inputting treatment area and treatment dosage information into said treatment planning software.

12. A system for interactive medical treatment planning involving multiple participants using multiple treatment planning stations, the system comprising:
means for establishing one of said treatment planning stations as a session controller and launching treatment planning software thereon;
means for establishing a communication connection between said session controller treatment planning station and all of said treatment planning stations participating in a planning session; and
means for displaying, on all participating treatment planning stations, treatment plan information being displayed on said session controller treatment planning station.

13. A system as set forth in claim 12, further comprising means for designating one of said treatment planning stations as an active controller, said active controller controlling manipulation of said treatment planning information.

14. A system as set forth in claim 13, wherein said active control of said treatment planning session is regulated by said session controller treatment planning station.

15. A system as set forth in claim 14, wherein designating means includes:
means for generation of an active-control request by a treatment planning station;
means for processing said active-control request by said session controller treatment planning station; and
means for authorizing or denying said active-control request by said session controller treatment planning station, wherein if said active-control request is granted, said treatment planning station generating said active-control request is given active control of said treatment planning session, and if said active-control request is denied, said treatment planning station generating said active-control request is denied active-control of said treatment planning session.

16. A system as set forth in claim 15, wherein at least two of said treatment planning stations are located in geographically diverse locations.

17. A system as set forth in claim 16, wherein each of said treatment planning stations includes video conferencing capability, and wherein said method further includes means for transmitting video and audio signals using said video conferencing capability of said treatment planning stations so that participants to said treatment planning session can see and hear the other participants in the session while the session is in progress.

18. A system as set forth in claim 17, wherein said treatment planning session is for planning radiation therapy and said participants in said treatment planning session include at least a dosimitrist and a radiation oncologist, each located at a geographically diverse location.

19. A system as set forth in claim 18, wherein said treatment planning stations are coupled to each other via a network connection.

20. A system as set forth in claim 8, wherein said network connection comprises the Internet.
